(19) United States
(12) Patent Application Publication
(10) Pub. No.: US 2011/0296071 A1
(43) Pub. Date: Dec. 1, 2011

(54) BLADE SERVER AND METHOD FOR ADDRESS ASSIGNMENT IN BLADE SERVER SYSTEM

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/939,104

(22) Filed: Nov. 3, 2010

(30) Foreign Application Priority Data
May 26, 2010 (TW) 99116753

(51) Int. Cl. G06F 9/00; G06F 13/40

(52) U.S. Cl. 710/300; 713/2

(57) ABSTRACT

A blade server and a method for auto-assigning a unique communication address for a blade server system. The blade server system includes a plurality of blade servers and a mainboard with a plurality of slots. The plurality of blade servers is received in the mainboard operating in the blade server system. The blade server includes at least one processor, a memory and a bus. The blade server connects the memory to the at least one processor by the bus and assigns a unique slot identification to the receiving slot. The blade server detects the unique slot identification of receiving slot of the mainboard. Then, the blade server assigns the unique communication address to the memory of the blade server according to the unique slot identification of the receiving slot.

### BACKGROUND

1. Technical Field

Embodiments of the present disclosure relate to system management and in particular to a blade server and method for auto-assigning a communication address in a blade server system.

2. Description of Related Art

A frequently used blade server system includes a blade enclosure with several slots, multiple blade servers, and a mainboard. A unique communication address is needed for each blade server to enable communication throughout the system.

As shown in FIG. 1, a blade server in a commonly used blade server system includes a processor, an Electrically Erasable Programmable Read-Only Memory (EEPROM) and an I2C bus. The EEPROM saves boot parameters for a boot function of the blade server. The I2C bus is a communication interface between the processor and the EEPROM. The processor executes the boot function of the blade server by reading the boot parameters from a corresponding EEPROM though an I2C communication address of the EEPROM. The I2C communication address is defined by two pins A00 and A11 of the EEPROM. The pins A00 and A11 connect two resistors R01 and R02 respectively. The I2C communication address can be defined by adjusting the pins A00 and A11 to change a resistance potential of the resistors R01 and R02. For example, if the I2C communication address of the EEPROM is defined as “0x50”, and several blade servers are attached to the mainboard of the blade server, duplicate I2C communication address “0x50” can be issued, arresting operations.

To avoid such issues, a unique communication address must be assigned to each blade server by manual adjustment of the pins, an inconvenient requirement, especially when a large number of blade servers are present.

### BRIEF DESCRIPTION OF THE DRAWINGS

FIG. 1 is a schematic diagram of one embodiment of a blade server in a commonly used system.

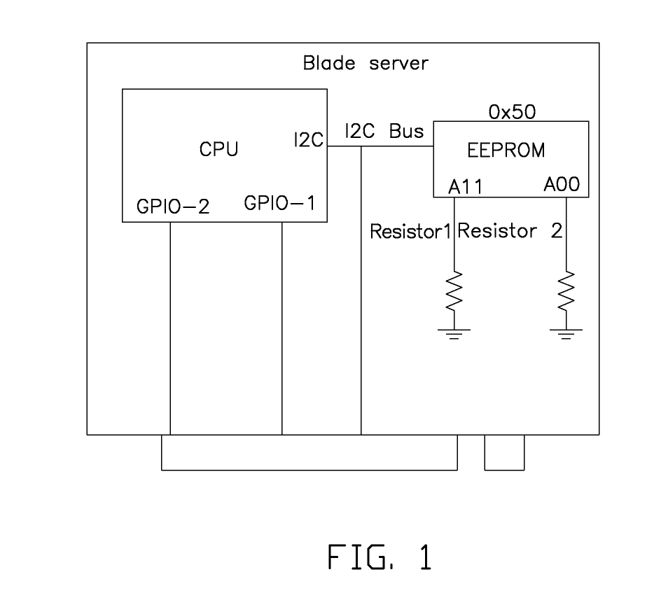

FIG. 2 is a block diagram of one embodiment of a blade server as disclosed.

FIG. 3 is a schematic diagram of one embodiment of a blade server system mounting a plurality of blade servers of FIG. 2.

FIG. 4 is a flowchart illustrating one embodiment of a method of address auto-assignment for a blade server operating in a blade server system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

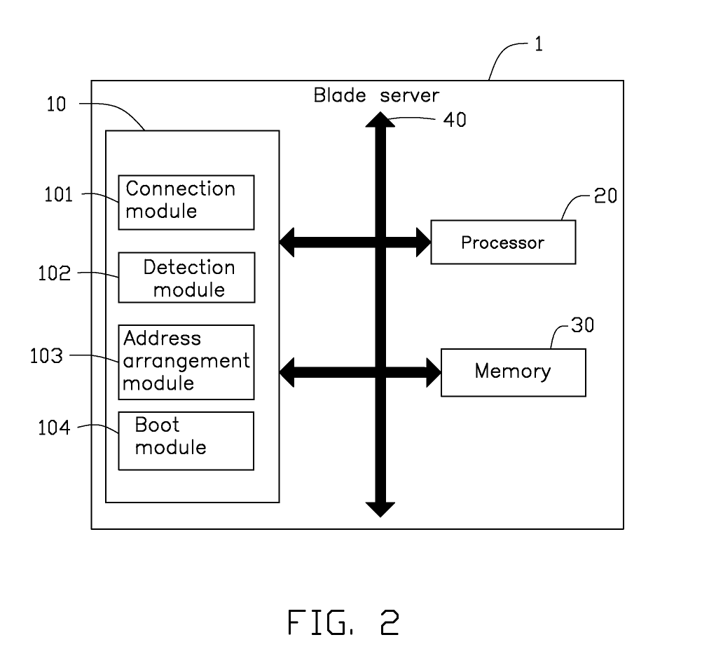

FIG. 2 is a block diagram of one embodiment of a blade server 1, including at least one processor 20, a memory 30, a bus 40, and one or more programs including a connection module 101, a detection module 102, an address assignment module 103 and a boot module 104. Depending on the embodiment, the blade server 1 may be a slot module used a blade server system. It should be understood that the slot module is a hardware module (e.g., a PCI module, hard disk module, processor module) that can be installed in slots of the blade server system

The blade server 1 is generally controlled and coordinated by an operating system application, such as UNIX, Linux, Windows 95, 98, NT, 2000, XP, Vista, Mac OS X, an embedded operating system, or any other compatible operating systems. In other embodiments, the blade server 1 may be controlled by a proprietary operating system. Conventional operating systems control and schedule computer processes for execution, perform memory management, provide file system, networking, and I/O services, and provide a user interface, such as a graphical user interface (GUI), among other things.

The memory 30 is electronically connected to the at least one processor 20, the connection module 101, the detection module 102, the address assignment module 103 and the boot module 104 by the bus 40. The bus 40 may be the I2C bus. The memory 30 is operable to store many kinds of data, such as the I2C communication address of the memory, a customization function code of the blade server 1, computerized codes of the modules 101-104, and firmware and an operating system of the blade server 1. In other embodiments, the memory 30 is an EEPROM including pin A0 and pin A1 connecting two resistors (not shown). The I2C communication address of the EEPROM can be defined by adjusting the resistance potential of the two resistors. The memory 30 may also include a flash memory, RAM, ROM, cache, or external storage media.

The modules 101-104 (the block 10 shown in FIG. 2) may comprise computerized code in the form of one or more programs that are stored in the memory 30. The computerized code includes instructions that are executed by the at least one processor 20 to provide functions for modules 101-104. The at least one processor 20 includes General-Purpose Input Output ports GPIO-1 and GPIO-2. In one embodiment, when the blade server 1 is received in a slot of a mainboard, the GIPO-1 and the GIPO-2 are connected with the pin A1 and pin A0 of the EEPROM respectively. The at least one processor 20 then communicates with the EEPROM by the I2C bus. In other embodiments, the at least one processor 20 can detect a slot identification of the slot of the mainboard by the GIPO-1 and the GIPO-2. The at least one processor 20, as an example, may include a CPU, math coprocessor, shift register, for example.

The connection module 101 is operable to connect the memory 30 to the at least one processor 20 by the bus 40 when the blade server 1 is received in the slot of the mainboard. In one embodiment, if the blade server 1 is received in the slot of the mainboard, the pin A1 and the pin A0 of the EEPROM connect the GIPO-1 and the GIPO-2 of the at least one processor 20. The connection module 101 can then connect the EEPROM to the at least one processor 20 by the bus 40.

The detection module 102 is operable to assign a unique slot identification to the slot upon detection that the slot receives the blade server 1. In one embodiment, the mainboard has a plurality of slots, each with two resistors. Unique slot identification is required to communicate with other slots. When of the blade servers 1 is received in of the slots, the detection module 102 can adjust the resistance potential of the two resistors of the receiving slot. Then, the detection module 102 assigns the unique slot identification to the receiving slot. The unique slot identification is a two bits value, such as “01”.

The address assignment module 103 is operable to assign a unique communication address to the memory 30 according to the unique slot identification of the receiving slot detected from the detection module 102. In one embodiment, when the blade servers 1 is received in the slot the mainboard, the address assignment module 103 assigns a unique I2C communication address to the EEPROM according to the assigned unique slot identification of the receiving slot. The address assignment module 103 assigns the unique I2C communication address by adjusting the resistance potential of the two resistors connecting the EEPROM. The EEPROM then saves the I2C communication address. For example, the address assignment module 103 can assign the I2C communication address “0x50” to the EPROM of the blade servers 1 and the I2C communication address “0x50” is saved in the EEPROM for communicating with the I2C bus.

The boot module 104 is operable to read the boot parameters from the memory 30 to boot the blade server 1. In one embodiment, the boot module 104 reads the boot parameters of the blade server 1 from one EEPROM by the I2C bus according to the assigned I2C communication address of the EEPROM. Accordingly, The plurality of blade servers 1 can avoid generation of duplicate addresses in the blade server.

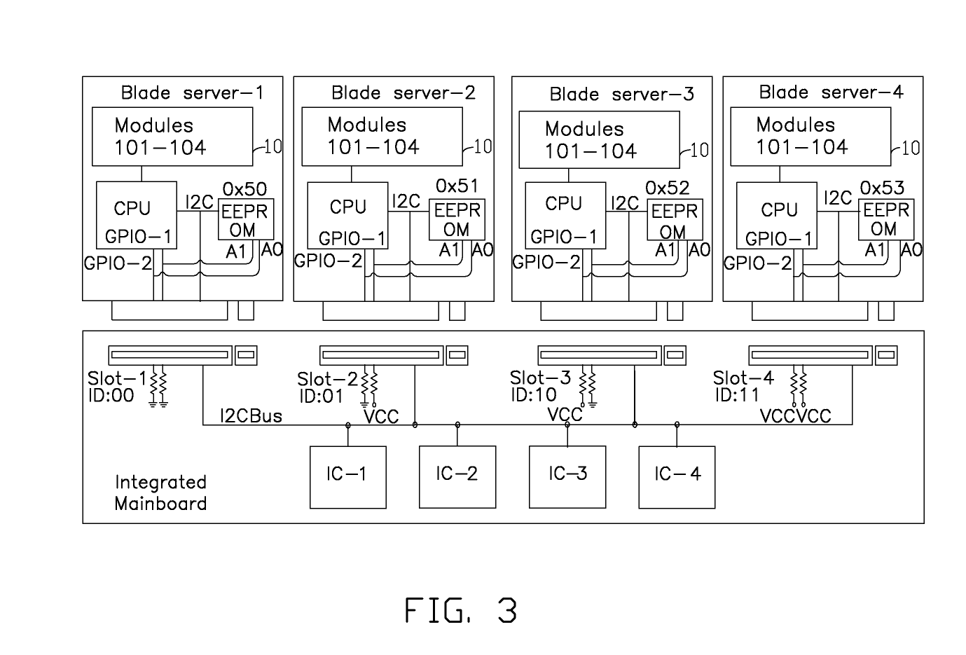

FIG. 3 is a schematic diagram of the blade server system housing a plurality of blade servers 1. In one embodiment, the blade server system includes four blade servers 1 (blade servers 1-4) and an integrated mainboard. The integrated mainboard includes four slots (slots 1-4) for receiving the four blade servers 1 and each slot includes two resistors R1 and R2. When the four blade servers 1 are received in the four slots of the mainboard, the detection module 102 can communicate with the four receiving slots by the I2C bus of the mainboard. The detection module 102 then assigns four unique slot identifications to the four receiving slots. The four unique slot identifications are adjusted by the resistance potentials of the four receiving slots. For example, the four unique slot identifications of the slots 1-4 can be assigned as “00”, “01”, “10” and “11”.

In addition, the four slots are connected by the I2C bus of the mainboard and the I2C bus connects four integrated circuits (ICs 1-4) of the integrated mainboard. Each integrated circuit can communicate with the I2C bus and the slots.

Each of the four blade servers 1 includes the at least one processor 20, the memory 30 and the bus 40. In one embodiment, the memory 30 is the EEPROM and the bus 40 is the I2C bus. Each EEPROM saves boot parameters for booting each blade server 1 received in the blade server system. The I2C bus is a communication interface between the at least one processor 20 and the EEPROM. Each processor 20 can assign the unique slot identification to each slot by adjusting the resistance potential of the two resistors of each receiving slot. For example, the address assignment module 103 assigns the I2C communication addresses “0x50”, “0x51”, “0x52” and “0x53” to the EEPROMs of the blade servers 1-4 respectively.

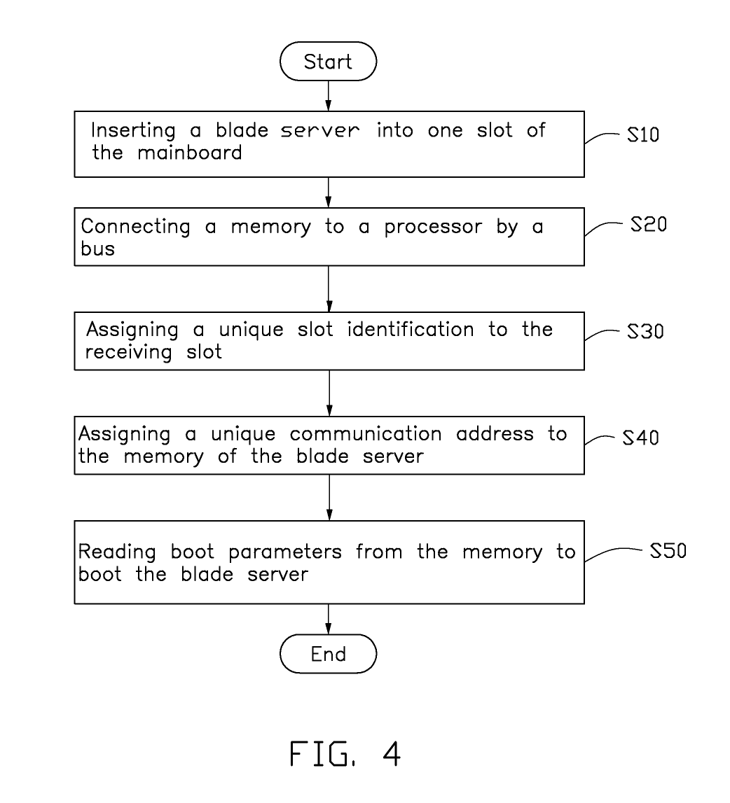

FIG. 4 is a flowchart illustrating an embodiment of a method for address auto-assignment of a blade server 1 operating in a blade server system. Depending on the embodiment, additional blocks may be added, others deleted, and the ordering of the blocks may be changed.

In block S10, the blade server 1 is received in a slot of a mainboard.

In block S20, the connection module 101 connects the memory 30 to the at least one processor 20 by the bus 40 when the blade server 1 is received in the slot of the mainboard. In one embodiment, the integrated mainboard with four slots receives the four blade servers 1. The connection module 101 connects the four EEPROMs to the four processors 20 by the I2C bus.

In block S30, the detection module 102 assigns the unique slot identification to the receiving slot of the mainboard. In one embodiment, the detection module 102 communicates with the four receiving slots by the I2C bus of the mainboard. Each slot includes two resistors R1 and R2. The detection module 102 then assigns four unique slot identifications to the four receiving slots. The four unique slot identifications are adjusted by the resistance potentials of the four receiving slots. For example, the four unique slot identifications of the slots 1-4 can be assigned as “00”, “01”, “10” and “11”.

In block S40, the address assignment module 103 assigns a unique communication address to the memory 30 of the blade server 1 according to the unique slot identification of the receiving slot. In one embodiment, the address assignment module 103 assigns the four unique slot identifications to the four receiving slots by adjusting the resistance potentials of the resistors of the four receiving slots. For example, the address assignment module 103 assigns the I2C communication addresses “0x50”, “0x51”, “0x52” and “0x53” to the EEPROMs of the blade servers 1-4 respectively.

In block S50, the boot module 104 reads the boot parameters from the memory 30 to boot the blade server 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A blade server operating in a blade server system, the blade server system comprising a plurality of blade servers and a mainboard with a plurality of slots, the blade server comprising:
at least one processor;
a memory;
a bus;
one or more programs stored in the memory and executed by the at least one processor, the one or more programs comprising:
a connection module operable to electronically connect the memory to the at least one processor by the bus upon the condition that the blade server is received in the slot of the mainboard;
a detection module operable to assign a unique slot identification to the receiving slot; and
an address assignment module operable to assign a unique communication address to the memory according to the unique slot identification of the receiving slot.

2. The blade server of claim 1, wherein the memory saves boot parameters for booting the blade server.

3. The blade server of claim 1, further comprising a boot module operable to read the boot parameters from the memory to boot the blade server.

4. The blade server of claim 1, wherein the memory comprise two resistors.

5. The blade server of claim 1, wherein the slot comprises two resistors to define the unique slot identification of the receiving slot.

6. The blade server of claim 1, wherein the bus is an I2C bus.

7. The blade server of claim 1, wherein the memory is an EEPROM.

8. The blade server of claim 1, wherein the unique communication address is an I2C communication address.

9. A method for address auto-assignment of a blade server operating in a blade server system including a mainboard with several slots, the blade server comprising at least one processor, a memory and a bus, the method comprising:
inserting the blade server into one slot of the mainboard;
connecting the memory to the at least one processor by the bus;
assigning a unique slot identification to the receiving slot of the mainboard; and
assigning a unique communication address to the memory of the blade server according to the unique slot identification of the receiving slot.

10. The method of claim 9, further comprising reading boot parameters from the memory to boot the blade server.

11. The method of claim 9, wherein assignment of the unique slot identification is adjusted by a resistance potential of the receiving slot.

12. The method of claim 9, wherein the resistance potential of the receiving slot is detected by two resistors.

13. A storage medium having stored thereon instructions that, when executed by a processor, cause the processor to perform a method for address auto-assignment of a blade server operating in a blade server system including a mainboard with several slots, the blade server comprising at least one processor, a memory and a bus, the method comprising:
inserting the blade server into one slot of the mainboard;
connecting the memory to the at least one processor by the bus;
assigning a unique slot identification to the receiving slot of the mainboard; and
assigning a unique communication address to the memory of the blade server according to the unique slot identification of the receiving slot.

14. The storage medium of claim 13, wherein the method further comprises reading boot parameters from the memory to boot the blade server.

15. The storage medium of claim 13, wherein assignment of the unique slot identification is adjusted by a resistance potential of the receiving slot.

16. The storage medium of claim 13, wherein the resistance potential of the receiving slot is detected by two resistors.
